(19) United States
(12) Patent Application Publication
(10) Pub. No.: US 2002/0128950 A1
(43) Pub. Date: Sep. 12, 2002

(54) Artificial intelligence based trading system

(76) Inventors: Michael Wu, Jersey City, NJ (US); Ruibin Liu, North York (CA); Bin Li, Westport, CT (US)

Correspondence Address: ST. ONGE STEWARD JOHNSTON & REENS, LLC, 986 BEDFORD STREET, STAMFORD, CT, 06905-5619, US

(21) Appl. No.: 09/804,005

(22) Filed: Mar. 12, 2001

(51) Int. Cl. G06F 17/60

(52) U.S. Cl. 705/37

(57) ABSTRACT

The invention relates to a system for online trading, including a computer, software permitting an investor to set a quantity of a particular financial asset to be automatically bought upon the occurrence of a first contingency, software permitting an investor to set an upper limit for selling the asset, whereby a match between the upper limit and market price triggers an automatic sale of the asset, software permitting an investor to set a lower limit for selling the asset, whereby a match between the lower limit and market price triggers the automatic sale, and software for monitoring for the occurrence of the first contingency and, once the first contingency occurs, for monitoring for a match between a market price and either of the upper or lower limits, a match automatically terminating the monitoring for the occurrence of the other limit.

### FIELD OF THE INVENTION

The invention relates to a web-based system for facilitating online trading and, more particularly, to a system that permits financial assets to be automatically traded upon conditional limitations being satisfied.

### BACKGROUND OF THE INVENTION

Trading stocks, bonds, securities, commodities, and other liquidities on the Internet provides a tremendous benefit to investors for it is more convenient and makes buying and selling easier for the investor. Generally, online trading sites also provide instructions to help investors use the sites to buy/sell their assets without the need for traders or brokers.

Because known online systems permit investors to buy/sell a variety of financial assets, investors seeking to maximize financial growth typically prefer to buy assets at low trading prices and sell them when the market prices for those particularly assets rise. Because financial markets and share prices fluctuate quickly and unpredictably at any moment and because an investor buys/sells based on fractional increases/decreases in market price, known systems permit an investor to set a trading price limit to sell assets that they own, whereby the systems automatically sell selected assets when the market price rises to a desirable selling price set according to the investor. This web-based feature is known to be a sell limit and is depicted in FIG. 1.

Similarly to the sell limit, known systems generally provide a sell stop limit as well. The sell stop limit permits an investor to set a low price for a financial asset below the price he paid when purchasing the asset. If the market price falls and matches the low price, the system automatically sells the asset, thereby cutting additional losses caused by continued market price decline. The sell stop limit is depicted in FIG. 2. Known systems further permit both the sell limit and sell stop limit to be specified, thereby defining a range in which to automatically sell financial assets. This is depicted in FIG. 4.

However, known systems further do not permit an investor to set the conditional range for automatically selling assets to be themselves dependent upon a condition precedent, or another contingent event, such as a particular market price for an asset. In other words, known systems do not permit the contingencies of sell/sell stop limits to be contingent upon another event, namely a buy limit order.

A buy limit order is defined to be a price and quantity of financial assets specified by an investor and permitted to be set by the system to automatically buy a specified amount of the financial asset when the market price matches the specified price. Hence, the buy limit order is contingent upon the market price matching the specified amount set by the investor.

In addition, known systems are typically limited to trading only financial assets that an investor owns at the time the trade is made and do not permit the flexibility of short sells. A short sell is defined to be the act of selling something you do not already have. Generally, one can borrow any stock from an online broker and sell it on the market. One's account will be accredited the proceeds and have a record that monies are owed to pay for the stock. The theory is that one who sells stocks under this condition will buy it back in a relatively short period of time at a lower price than which it was sold and then transfer the stock back to the broker from whom the stock was borrowed. Hence, one makes a profit based upon the borrowed stock. For example, assume the market price of IBM is $120 per share. An investor believes that it will soon drop to $110. You can short sell 100 shares of IBM at $120, so that your account will be accredited $12,000, and will earn interest on it. Three days later (an arbitrary time period), if IBM drops to $110, you can buy 100 shares back from the market by debiting $11,000 from your account and return the shares back to the broker.

However, should the stock rise in market price, one is obligated to buy back the stock at the higher price than which it was sold in order to transfer the borrowed stock back to the broker. Hence, the investor loses money. Therefore, short sells are risky and are generally for investors who will quickly buy the asset he has just sold and in such time before the borrowed asset is due.

What is desired, therefore, is a system for facilitating online trading. What is further desired is a system that permits a conditional and adjustable price range to be set from which financial assets may be traded. What is still further desired is a system that permits the price range to be conditional upon another conditional event. What is still further desired is a system that operates automatically when either condition occurs.

### SUMMARY OF THE INVENTION

Accordingly, it is an object of the invention to provide a web-based system for facilitating online trading of financial assets.

It is still another object of the invention to provide a system that permits the conditional and/or adjustable price range to be conditional upon another condition or event occurring.

It is yet another object of the invention to provide a system that operates automatically without user intervention.

It yet still another object of the invention to provide a system that, upon the occurrence of a condition, automatically cancels other conditions.

It is yet another object of the invention to automatically monitor, in real time, financial markets for the occurrence of a condition or event.

These and other objects of the invention are achieved by a system for online trading, including a computer, software permitting an investor to set a quantity of a particular financial asset to be automatically bought upon the occurrence of a first contingency, software permitting an investor to set an upper limit for selling the asset, whereby a match between the upper limit and market price triggers an automatic sale of the asset, software permitting an investor to set a lower limit for selling the asset, whereby a match between the lower limit and market price triggers the automatic sale, and software for monitoring for the occurrence of the first contingency and, once the first contingency occurs, for monitoring for a match between a market price and either of the upper or lower limits, a match automatically terminating the monitoring for the occurrence of the other limit.

The system may further include software permitting an investor to set a particular purchase price for purchasing the asset, time for purchasing the asset, or a both, whereby a match between the specified purchase price and/or time and market price or time specified for purchasing the asset automatically triggers a purchase.

In addition, the system may include software permitting the investor to contemporaneously set the quantity, purchase price, upper selling limit, lower selling limit, purchase price, and combinations thereof.

The system may also include a database for storing the purchase price or other conditions of the financial asset such that the computer can retrieve them from memory when determining a match or condition being satisfied. Further, the system permits the financial asset to be bought/sold in whole or in part.

In another embodiment of the invention, the system provides the inventor with the ability to sell assets he does not own at the time of the sale. The system includes software permitting an investor to sell a specified financial asset he does not necessarily own at the time of the sale, software permitting the investor to specify an upper buying limit for buying the financial asset he has just sold, whereby a match between the upper limit and market price triggers an automatic purchase, and software permitting the investor to specify a lower buying limit for buying the financial asset he has just sold, whereby a match between the lower limit and market price triggers an automatic purchase of the asset.

The system may further include software for receiving an indication, such as a condition precedent, from an investor to automatically sell the asset as opposed to requiring investor intervention. Such condition precedents include a match between a desirable selling price and market price. In addition, the system may further include software for automatically notifying the investor that a condition for purchasing the asset has been satisfied, thereby permitting an investor to optionally purchase the asset.

The invention and its particular features and advantages will become more apparent from the following detailed description considered with reference to the accompanying drawings.

### BRIEF DESCRIPTION OF THE DRAWINGS

FIG. 1 depicts a graph of a known system for automatically selling a financial asset after its market price has risen.

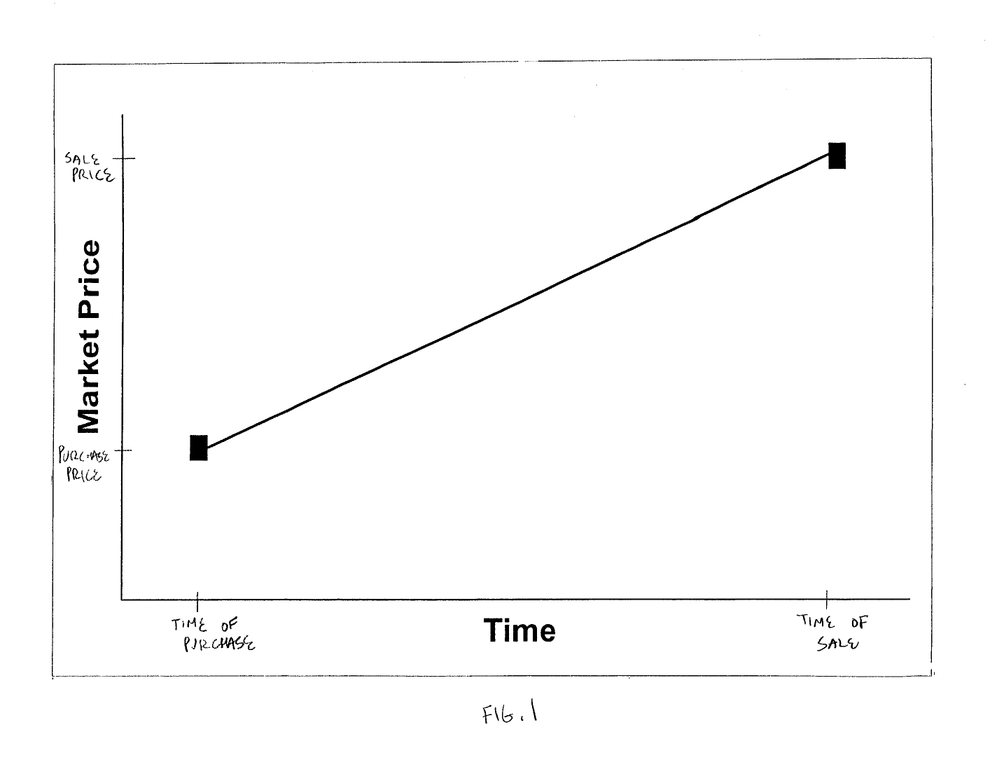

FIG. 2 depicts a graph of a known system for automatically selling a financial asset after its market price has fallen.

FIG. 3 depicts a graph of the system in accordance with the invention for conditionally and automatically purchasing a financial asset and having upper and lower limits for automatically selling the asset.

FIG. 4 depicts a graph of a known system providing a range for automatically selling a financial asset.

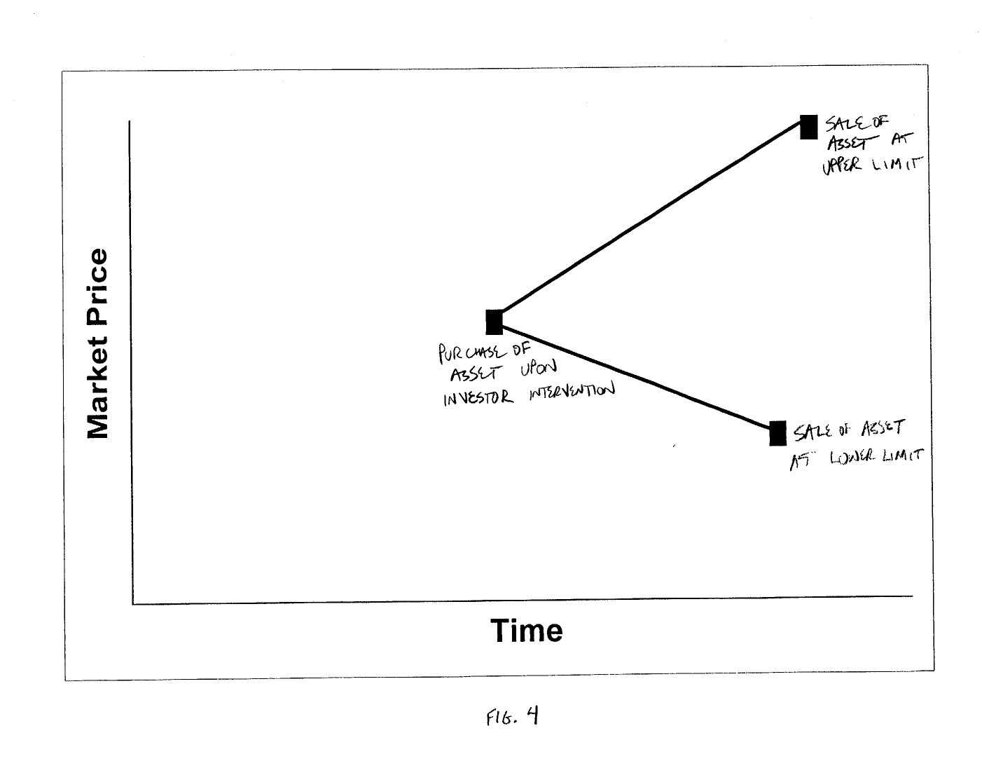

FIG. 5 depicts a graph of an alternative embodiment of the invention for conditionally and automatically selling a financial asset and having upper and lower limits for automatically buying the asset.

FIG. 6 depicts a flowchart of the system in accordance with the invention.

FIG. 7 depicts a flowchart of an alternative embodiment of the invention.

FIG. 8 depicts another alternative embodiment of the invention.

### DETAILED DESCRIPTION OF THE DRAWINGS

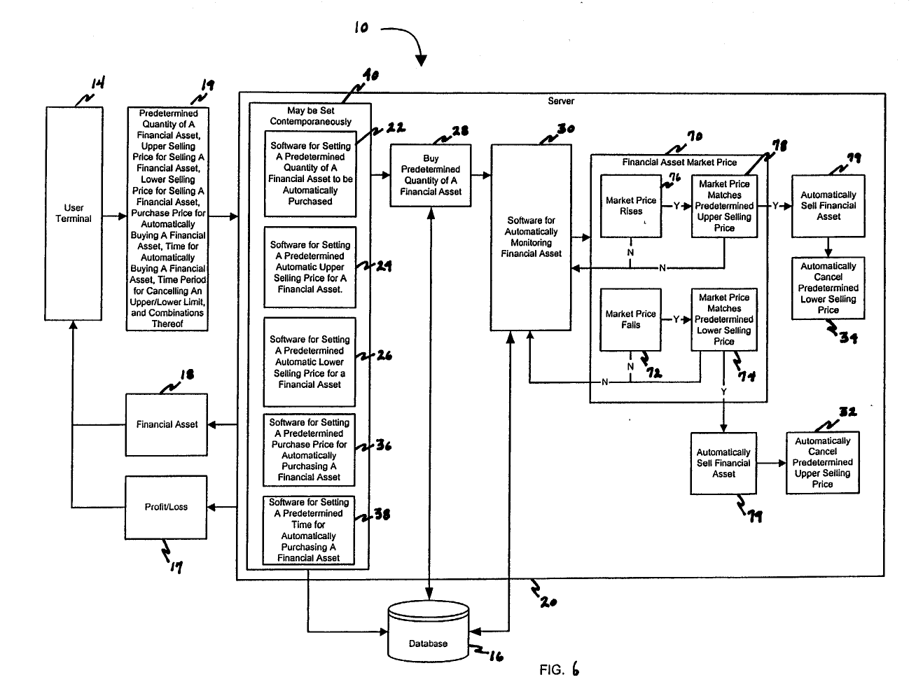

FIG. 6 depicts the system in accordance with the invention. System includes user terminal 14 and server 20. User terminal 14 may be a computer in connection with server 20, whereby a user operating user terminal 14 issues commands and instructions to server 20 to automatically buy and/or sell financial assets 18. After receiving the commands, system 10 then automatically operates to carry out the commands. System 10 may further automatically buy/sell financial assets upon a condition or event occurring, whereby the condition or event is contingent upon a further condition or event occurring.

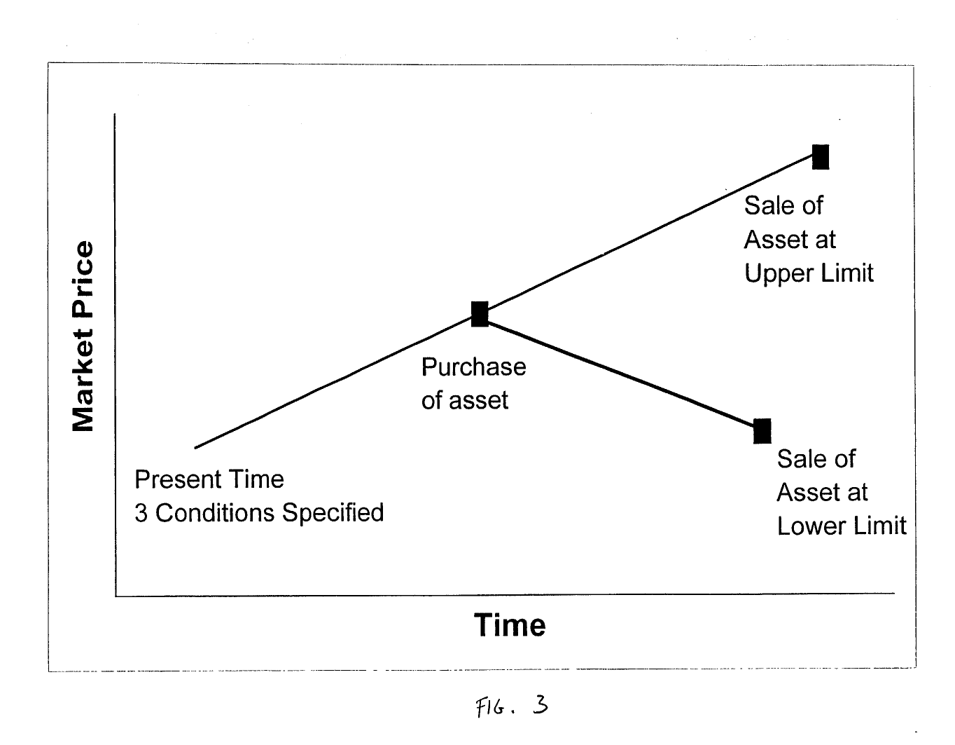

System 10 operates to facilitate online trading by providing automatic purchasing and/or selling of asset 18 when certain conditions present themselves that make it desirable for an investor to buy or sell. For example, an investor may desire to buy asset 18 at a particular market price and sell it if the market price rises 76, thereby giving the investor a profit. Should the market price fall 72 subsequent to being bought, the investor may wish to cut his loss and sell asset 18 before the market price drops any further. Hence, system 10 provides a range, having an upper limit and a lower limit, for selling asset 18, whereby the market price matching, 78 and 74, respectively, either the upper or lower limit triggers sale 79. FIG. 3 more particularly depicts system 10 for conditionally and automatically purchasing asset 18 and having an upper and lower limit for automatically selling the asset. Sale 79 also contemporaneously prompts system 10 to cancel 32 the upper limit, if the market price matched 74 the lower limit, and to cancel 34 the lower limit, if the market price matched 78 the upper limit.

It should be noted that matching does not need to be exact. System 10 permits the investor to determine how close in proximity the market price needs to come to the upper and/or lower limits he sets before system 10 recognizes a match and automatically sells asset 18 and cancel the opposing limit, 32 and 34. For example, system 10 may find a match when the upper/lower limit comes within 1% of the market price. The percentage may further be adjusted to 5%, 10%, or any arbitrary percentage. In another example, system 10, while monitoring 70 asset market price, may be programmed or commanded by the investor to round a market price to the nearest whole dollar amount. Hence, a match would be found between an upper limit of $80/share and a market price of $79.80/share. System 10 may further receive other commands to set rounding to other increments, such as nearest tenth of a dollar amount, nearest ten dollars, or any arbitrary value including no rounding, meaning an exact match is required between an upper or lower limit and market price.

Software 30 for monitoring market price fluctuations 70 executes on server 20 and monitors the financial markets on a continuous basis. Monitoring may be performed on a weekly, daily, hourly, real time, or other basis or time period. The frequency of monitoring market price is arbitrary and is not to be a limiting factor of the invention. Monitoring is performed by system 10 at arbitrarily determined time periods, whereby system 10 automatically and continuously compares the market price with the purchase price, which was stored on database 16 at the time system 10 purchased 28 asset 18.

Server 20 includes software 22 for receiving an indication from an investor of a specific quantity of a particular financial asset 18, software 24 for receiving an indication from an investor of an upper limit selling price, software 26 for receiving an indication from an investor of a lower limit selling price, software 28 for automatically buying asset 18, software 30 for monitoring for market price fluctuations 70 and, more particularly, the occurrence of either the upper limit or lower limit, and software 32 for canceling the upper limit upon the occurrence of the lower limit and, vice versa, software 34 for canceling the lower limit upon the occurrence of the upper limit. The cancellation of either upper or lower limit may be subsequent to or contemporaneous with the sale of asset 18 upon a match, 74 and 78, occurring with either upper or lower limit. System 10 cancels an upper or lower limit by ceasing to monitor the no longer needed limit or erasing/deleting the limit from database 16. Server 20 may further include software 36 for setting a specific purchase price and software 38 for setting a specific time, the occurrence of either or both triggers system 10 to automatically purchase asset 18.

The investor may contemporaneously specify 40 his commands 19, or conditions, for system 10 to automatically carry out. Commands 19 include the quantity 22 of asset 18 to be purchased, upper selling price limit for automatically selling asset 18, lower selling price limit for automatically selling asset 18, the desired purchase price 36 for automatically purchasing asset 18 when the market price matches the set purchase price 36, the time 38 for making a purchase of asset 18, and any combination thereof. Permitting the investor to simultaneously set one or more of these conditions facilitates the use of the invention and the online trading experience for the conditions, once specified, will execute automatically without user intervention. Once one or more of the above conditions are specified, it is stored on database 16 for executing the trade if, or when, the corresponding condition is satisfied.

For example, asset 18 is automatically purchased when the market price matches the specified price 36 at time 38. If the market price rises to match 78 upper limit or falls to match 74 lower limit, the asset is sold. Should the investor not specify purchase price 36, he can simple specify time 38 and system 10 will automatically purchase the desired quantity of asset 18 at time 38 at the then current market price. If both purchase price 36 and time 38 are not specified, then system 10 automatically buys the asset at market price upon the inventor commanding the purchase to occur, generally when the inventor intervenes or causes system 10 to execute the purchase. Subsequently, system 10 operates to provide a range for automatically selling asset 18.

An investor may specify his commands 19 using known or novel methods, such as system 10 prompting the investor to input purchase price, asset identification, upper selling limit, lower selling limit, and the like. Commands 19 are inputted at user terminal 14, an investor's computer that may be remotely located from server 20, such as an Internet or wireless location. Commands 19 are transmitted to server 20, which may be another computer, for carrying out the inventor's commands.

Server 20, depending upon whether the investor specifies a condition for purchasing a quantity of asset 18, either stores a purchase price and/or time for automatically purchasing asset on data 16 or immediately buys 28 asset 18 at current market price. If a condition is specified, system 10 monitors the financial asset's fluctuations and would execute the purchase upon the condition being satisfied, or the purchase price and/or time matching market price or correct date/time.

The upper and lower selling price limits are stored on database 16 and system 10 thereafter continuously monitors the market in order to automatically execute a sale of asset 18 upon a match between market price and either limit. It should be noted that the upper selling price limit should be higher than the purchase price of asset 18, which is stored on database 16. System 10 may transmit notification to user terminal 14 if the upper selling price limit is equal to or less than the purchase price, thereby prompting the investor to specify an upper selling price limit higher than the purchase price. Similarly, if the lower selling price limit is not lower than the purchase price, notification is transmitted.

Upon an upper or lower selling price limit being matched, asset 18 is automatically sold. The proceeds resulting from the sale, profit/loss 17, is then sent to the investor through known or novel methods, such as electronically debiting/crediting his account or mailing him a check/invoice.

It should be noted that an upper or lower selling price limit may not be matched, or the condition never satisfied. The matching or condition may also be satisfied at a time much later than anticipated or desired by the investor, such as a day trader who makes trades on a short term basis and may forget about an upper or lower limit he set many weeks ago. In general, setting a time for canceling conditions is beneficial for an investor who holds assets for time periods relatively short so as not to realize long term capital gains.

Therefore, it may be desirable for the investor to specify a time for canceling the upper and/or lower limits. The time is generally an arbitrarily determined period after the purchase 28 of asset 18 and may be minutes, hours, days, weeks, months, or years.

Also, the time period between the purchase and sale of financial asset 18 is adjustable from asset to asset. Further, the time for canceling an upper limit may be different from a time to cancel the lower limit for the same asset. It should be noted that a time period need not be specified to cancel conditions in order for system 10 to function properly. System 10 may function without setting a time period at all, meaning the upper/lower limits or conditions will not be canceled no matter how much time has passed after the purchase 28 of asset 18. In addition, a time period may also be used to automatically cancel the purchase 28 of asset 18 if purchasing conditions have not been met in a timely manner.

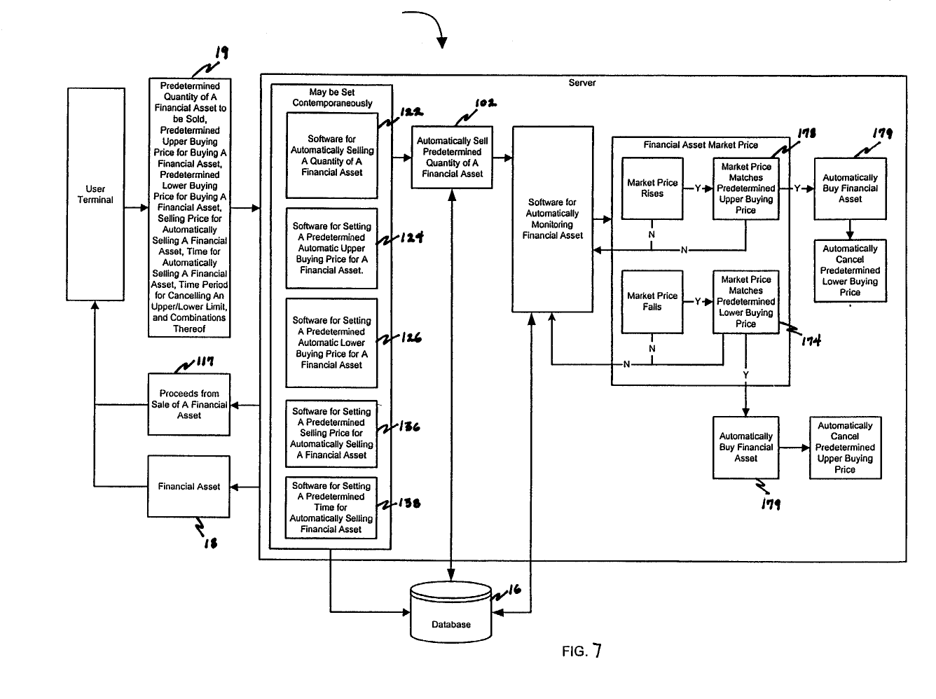

FIG. 7 depicts another embodiment of the invention for providing a short sell. A short sell is defined to be the act of selling something you do not already have. Generally, one can borrow any stock from an online broker and sell it on the market. One's account will be accredited the proceeds 117 and have a record that monies are owed to pay for the stock. The theory is that one who sells stocks under this condition will buy it back in a relatively short period of time at a lower price than which it was sold and then transfer the stock back to the broker from whom the stock was borrowed. Hence, one makes a profit based upon the borrowed stock. For example, assume the market price of IBM is $120 per share. An investor believes that it will soon drop to $110. You can short sell 100 shares of IBM at $120, so that your account will be accredited $12,000, and will earn interest on it. Three days later (an arbitrary time period), if IBM drops to $110, you can buy 100 shares back from the market by debiting $11,000 from your account and return the shares back to the broker.

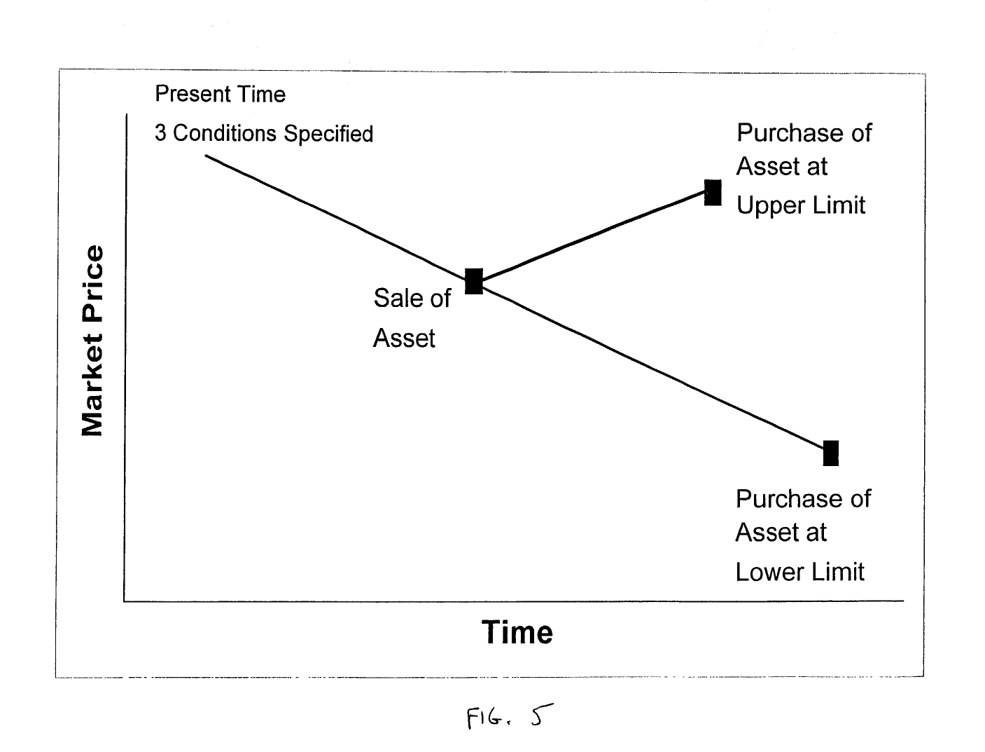

However, should the stock rise in market price, one is obligated to buy back the stock at the higher price than which it was sold in order to transfer the borrowed stock back to the broker. Hence, the investor loses money. Therefore, short sells are risky and are generally for investors who will quickly buy the asset he has just sold and in such time before the borrowed asset is due. FIG. 5 more particularly depicts system 10 for selling an asset and having an upper and lower limit for automatically buying back the asset

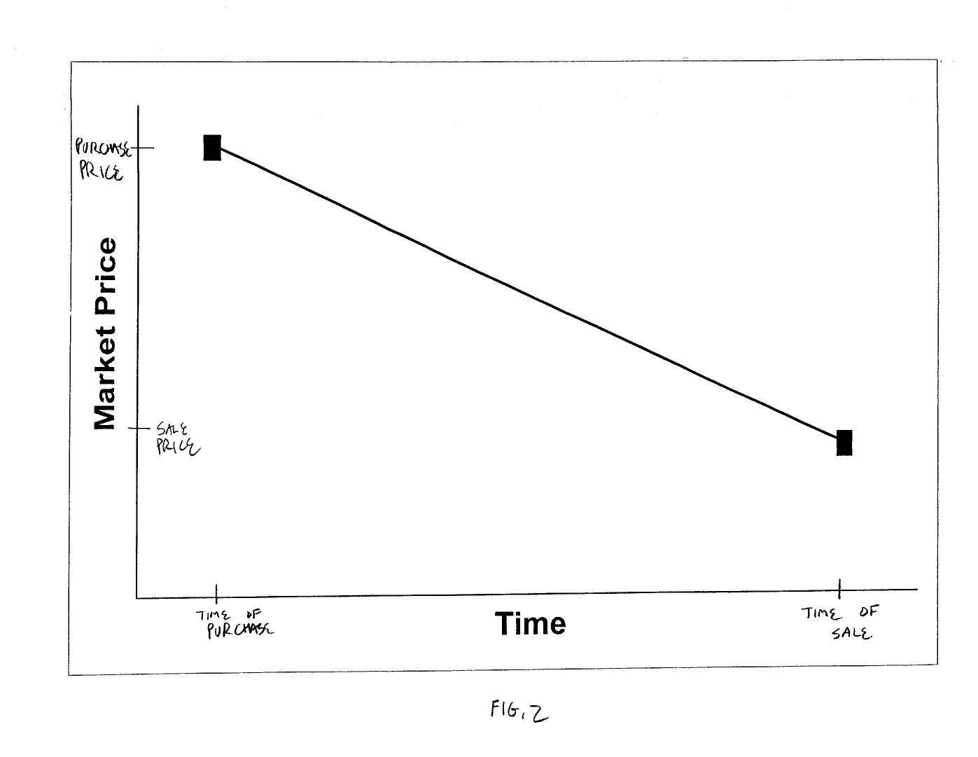

The embodiment depicted in FIG. 7 includes all the limitations as described under FIG. 6. The underlying difference of this embodiment from that depicted in FIG. 6 is that an investor's first trade will be that of an automatic sale followed by an automatic purchase of asset 18. System 10 generally operates in similar fashion as the embodiment depicted in FIG. 6 except sales occur in FIG. 6 when they were purchases in FIG. 7 and purchases occur in FIG. 6 when they were sales in FIG. 7. Hence, for the embodiment depicted in FIG. 2, upper and lower limits are applicable to purchase, not sell, the specified asset when a match occurs with the market price.

In this embodiment, system 10 includes software 122 for selling asset 18, software 124 for specifying an upper buying price limit for automatically buying asset 18, software 126 for specifying a lower buying price limit for automatically buying asset 18, software 136 for specifying the desired selling price for automatically selling asset 18 when the market price matches the specified selling price, software 138 for specifying the time for making a sale of asset 18, and any combination thereof. Similar to FIG. 6, this embodiment permits the investor to contemporaneously set one or more of these conditions to facilitate use of the invention and the online trading experience for the conditions, once specified, will execute automatically without user intervention. Once one or more of the above conditions are specified, it is stored on database 16 for executing the trade if, or when, the corresponding condition is satisfied.

If the market price rises to match 178 upper limit or falls to match 174 lower limit, the asset is bought. Should the investor not specify a selling price, system 10 will automatically sell 102 the desired quantity of asset 18 at the current market price. If both the selling price and time for selling the asset are not specified, then system 10 automatically sells 102 the asset at market price upon the inventor commanding the sale to occur, generally when the inventor intervenes or causes system 10 to execute the sale.

Upon a match between a market price and upper or lower buying price limit occurring, system 10 automatically buys 179 asset 18. Subsequent to or contemporaneously with purchasing 179 the asset, system 10 cancels the upper buying limit upon the occurrence of a match between the lower buying limit and market price and, vice versa, cancels the lower buying limit upon the occurrence of a match between the upper buying limit and market price.

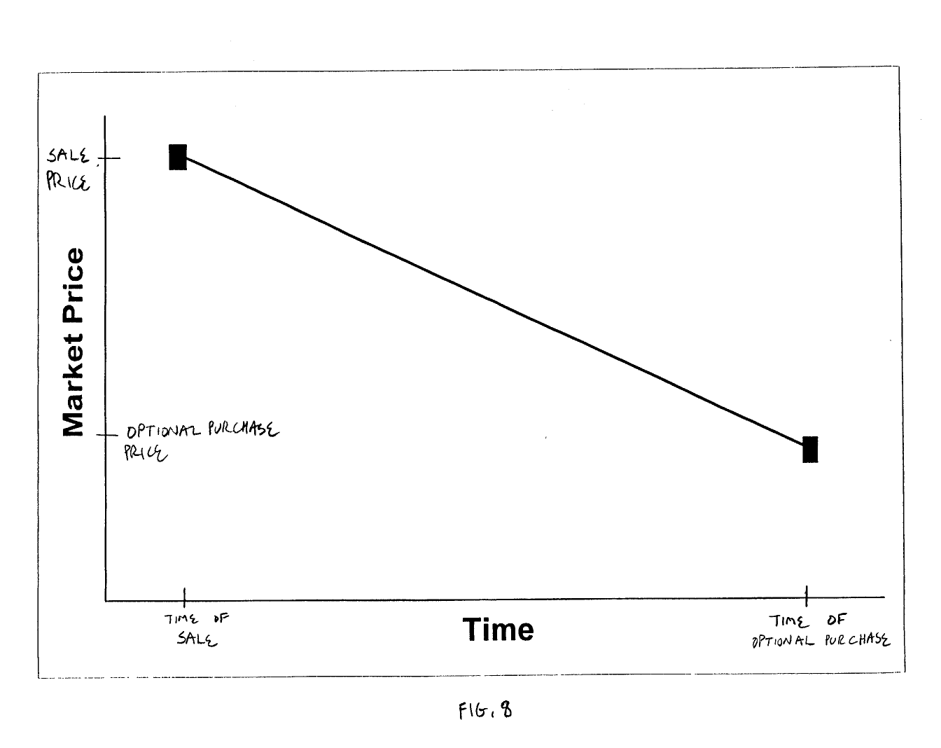

FIG. 8 depicts another alternative embodiment in which the system automatically buys a financial asset that was previously sold at a higher price. An investor who believes a stock has long-term benefits but is currently at an elevated trading price above the market price may choose to sell the stock with the intention of buying it back at a later time should the price fall. After the sale, system 10 monitors the market to see if the market price for the stock just sold drops and, if it drops to an amount specified by the investor, automatically repurchases the stock or automatically notifies the investor so that the investor can make a decision whether to repurchase the asset or not.

This embodiment is similar to the short sell depicted in FIG. 7, in which an investor sells an asset he has borrowed and repurchases such an asset in order to return the borrowed asset. However, the alternative embodiment depicted in FIG. 8 differs in that it pertains to selling assets owned, not borrowed, by the investor. In addition, this alternative embodiment pertains to repurchasing assets at the investor's option, whereas the embodiment depicted in FIG. 7 mandates that the assets be repurchased.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for online trading, comprising:
a computer;
software executing on said computer for receiving an indication from an investor of a specified quantity of a specified financial asset to be bought upon the occurrence of a specified first contingency;
software executing on said computer for receiving an indication from an investor of a specified second contingency, the occurrence of which will trigger the sale of the specified financial asset;
software executing on said computer for receiving an indication from an investor of a specified third contingency, the occurrence of which will trigger the sale of the specified financial asset;
software executing on said computer for monitoring for the occurrence of the specified first contingency, and upon the occurrence of the specified first contingency for automatically buying the specified quantity of the specified financial asset; and
software executing on said computer for monitoring for the occurrence of the first contingency and, once the specified first contingency has occurred, monitoring for the occurrence of the specified second contingency and the specified third contingency for, upon the occurrence of the specified second contingency, automatically selling the financial asset and terminating monitoring for the occurrence of the specified third contingency, and for, upon the occurrence of the specified third contingency, automatically selling the financial asset and terminating monitoring for the occurrence of the specified second contingency.

2. The system according to claim 1, wherein said first contingency is a time for purchasing the specified quantity of the specified financial asset, a purchase price for purchasing the specified quantity of the specified financial asset, or combination thereof.

3. The system according to claim 1, further including software executing on said computer for receiving an indication from the investor to contemporaneously set said specified quantity, said specified first contingency, said specified second contingency, said specified third contingency, and combinations thereof.

4. The system according to claim 1, further including a database accessible by said computer for storing a purchase price of the financial asset on said database.

5. The system according to claim 4, wherein said software executing on said computer stores the purchase price of said specified quantity of the financial asset on said database.

6. The system according to claim 1, wherein the financial asset sold is a portion of the financial asset bought.

7. The system according to claim 1, wherein said second contingency is a selling price higher than a purchase price of the specified quantity of the specified financial asset.

8. The system according to claim 1, wherein said third contingency is a selling price lower than a purchase price of the specified quantity of the specified financial asset.

9. A system for online trading, comprising:
a computer;
software executing on said computer for receiving an indication from an investor to sell a specified financial asset, whereby the investor does not own the specified financial asset at the time of the sale;
software executing on said computer for receiving an indication from the investor of a specified first contingency, the occurrence of which will trigger the purchase of the financial asset; and
software executing on said computer for receiving an indication from the investor of a specified second contingency, the occurrence of which will trigger the purchase of the financial asset.

10. The system according to claim 9, wherein said first contingency is a purchase price higher than a selling price.

11. The system according to claim 9, wherein said second contingency is a purchase price lower than a selling price.

12. The system according to claim 9, further including software executing on said computer for receiving an indication from an investor to automatically sell the financial asset.

13. A system for online trading, comprising:
a computer;
software executing on said computer for receiving an indication from an investor to sell a financial asset; and
software executing on said computer for receiving an indication from the investor of a specified lower buying price limit for automatically purchasing the financial asset when a market price of the financial asset matches said specified lower buying price limit.

14. The system according to claim 13, further including software executing on said computer for receiving an indication from the investor to cease purchasing the financial asset.

15. The system according to claim 13, further including software executing on said computer for automatically transmitting an indication that a condition for purchasing the asset has been satisfied.
